(19) United States
(12) Patent Application Publication
(10) Pub. No.: US 2007/0154179 A1
(43) Pub. Date: Jul. 5, 2007

(54) Information playback apparatus

(76) Inventor: Daisuke Takeuchi, Ome-shi (JP)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/638,491

(22) Filed: Dec. 14, 2006

(30) Foreign Application Priority Data
Dec. 26, 2005 (JP) 2005-373506

(51) Int. Cl. H04N 7/00

(52) U.S. Cl. 386/95

(57) ABSTRACT

According to one embodiment, an information playback apparatus plays back content of an optical disk and hard disk, and displays the content on a display device. The information playback apparatus has a menu window display processing unit which stops playback of the content upon pressing a menu key during playback of the content, and displays a menu window in place of the content on the display device. The information playback apparatus also has a resume playback processing unit which resumes playback of the stopped content upon pressing a resume key while displaying the menu window on the display device, and displays the resume-played content in place of the menu window on the display device.

### CROSS-REFERENCE TO RELATED APPLICATIONS

This application is based upon and claims the benefit of priority from Japanese Patent Application No. 2005-373506, filed Dec. 26, 2005, the entire contents of which are incorporated herein by reference.

### BACKGROUND

1. Field

One embodiment of the invention relates to an information playback apparatus which plays back information recorded on a recording medium such as an optical disk (e.g., a DVD) and a hard disk.

2. Description of the Related Art

Recently, an information playback apparatus which plays back information (also referred to as “content” hereinafter) recorded on a recording medium such as an optical disk (e.g., a DVD) and a hard disk has become popular.

In recording content on the recording medium, the recording medium stores various mixed data by employing an image data compression technique such as MPEG2, and an audio data compression technique. The recording medium also stores control data such as navigation pack information in order to implement various functions.

For example, in recording content such as a movie or drama on a DVD, the DVD generally records video data and audio data. Additionally, when the DVD records caption data in a plurality of languages, the information playback apparatus can display the caption data in a language selected by a user. When the DVD also records audio dubbing data in a plurality of languages, the information playback apparatus can output the audio dubbing data in a language selected by the user. Furthermore, when the DVD records still image data for introducing the profiles and the like of a director and the cast, the information playback apparatus can display the still image data in accordance with user operation.

In order to accept requests for such various functions from the user, this type of information playback apparatus has a menu window display function. This menu window display function includes a function of displaying an operation button selected by the user on a menu window, and a highlighting function of notifying the user that a desired operation button is accurately selected. The menu includes menu items of title, route, audio, sub-picture, angle, chapter, and the like.

In order to display the menu window on a display, the user presses a menu key arranged in a remote controller or the operation unit of a main body. The user may press the menu key during playback of content. Upon depression of the menu key during playback of the content, the information playback apparatus stops playback of the content, stores resume information at this time in a memory, and displays the menu window on the display.

This type of information playback apparatus also has a resume function of resuming playback of the content from a stop position with reference to resume information in the memory upon pressing the menu key again while stopping playback of the content to display the menu window on the display.

However, the resume function implemented upon pressing the menu key again is not well known by the user.

It is disclosed by, for example, Jpn. Pat. Appln. KOKAI Publication No. 2005-203060 to provide a technique of reliably notifying a user of such resume function. In Jpn. Pat. Appln. KOKAI Publication No. 2005-203060, a message indicating that “content is played back from the stop position by pressing the menu key” is displayed when the user presses the menu key while displaying the menu window. After that, when the user presses the menu key again in accordance with this message, playback is resumed.

As described above, the conventional information playback apparatus has a function of resuming playback upon pressing the menu key again while stopping playback of content to display a menu window on a display. However, this operation is not user-friendly. Playback of content cannot be always resumed depending on the content even upon pressing the menu key. That is, this function depends on the type of content. Therefore, this function can be implemented for one type of content, but cannot sometimes be implemented for another type of content. Hence, such inconsistency may have disabled implementation of a user-friendly user interface.

Even in Jpn. Pat. Appln. KOKAI Publication No. 2005-203060, the user must press the menu key in either case in order to display the message indicating that “content is played back from the stop position by pressing the menu key”. Hence, this technique is not a drastic solution to the problem because the message cannot be displayed unless the user presses the menu key.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is a functional block diagram showing the arrangement of an information playback apparatus according to an embodiment of the invention; and

FIG. 2 is a flowchart showing an example of a process associated with a resume key in the information playback apparatus according to the embodiment.

### DETAILED DESCRIPTION

Various embodiments according to the invention will be described hereinafter with reference to the accompanying drawings. In general, according to one embodiment of the invention, an information playback apparatus which plays back information recorded on a recording medium, and displays the information on a display unit, comprises a menu window display processing unit, and a resume playback processing unit. When pressing a menu key during playback of the information, the menu window display processing unit stops playback of the information and displays a menu window in place of the information on the display unit. When pressing a resume key while displaying the menu window on the display unit, the resume playback processing unit resumes playback of the information stopped to be played back, and displays the resume-played information in place of the menu window on the display device.

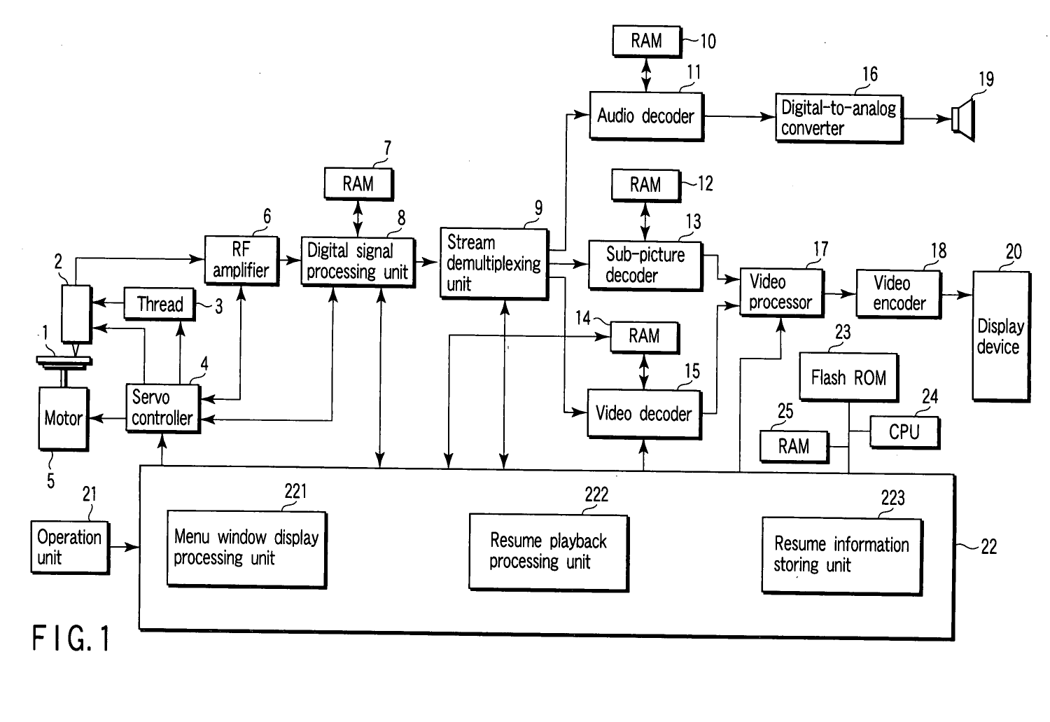

According to an embodiment, FIG. 1 shows a functional block diagram of the arrangement of an information playback apparatus.

That is, the information playback apparatus according to this embodiment plays back content recorded on a recording medium such as an optical disk (e.g., an HD-DVD) and a hard disk, and displays the recorded content on a display device 20. The information playback apparatus includes a spindle motor 5, optical pickup 2, thread 3, and servo controller 4. The spindle motor 5 rotates an optical disk 1. The optical pickup 2 emits a laser beam to play back content recorded on the optical disk 1, and receives reflected light from the optical disk 1. The thread 3 moves the optical pickup 2 in the radial direction of the optical disk 1. The servo controller 4 drives the spindle motor 5 and thread 3 in accordance with an instruction from a system controller 22 (to be described later), and moves an objective lens (not shown) incorporated in the optical pickup 2 to move the focus position of the laser beam in the vertical and horizontal directions with respect to the recording surface of the optical disk 1.

Note that the information playback apparatus according to this embodiment plays back not only content recorded on the optical disk 1 as the recording medium but also content stored in a hard disk. Hence, the information playback apparatus also has a hard disk (not shown). In addition to a mechanism for reading the content recorded on the optical disk 1, the information playback apparatus includes a motor, read head, thread, and servo controller as a mechanism for reading the content stored in the hard disk. The motor rotates the hard disk. The read head corresponds to the optical pickup 2. The thread moves this read head in the radial direction of the hard disk. The servo controller controls, in accordance with an instruction from the system controller 22, to move the position of the read head in the vertical and horizontal directions with respect to the recording surface of the hard disk.

The information playback apparatus also includes an RF amplifier 6, digital signal processing unit 8, and stream demultiplexing unit 9. The RF amplifier 6 amplifies an RF signal serving as a read signal output from the optical pickup 2 in playing back the content on the optical disk 1, or from the read head (not shown) in playing back the content in the hard disk. After converting the RF signal output from the RF amplifier 6 into digital data, the digital signal processing unit 8 executes a signal demodulating process and error correction process for the converted digital data in accordance with the data format of the optical disk 1 or hard disk, and stores the obtained data in a RAM 7. The stream demultiplexing unit 9 demultiplexes the data stream from the digital signal processing unit 8 into audio data, sub-picture data, and video data, in accordance with instructions from the system controller 22.

The information playback apparatus also includes an audio decoder 11, RAM 10, sub-picture decoder 13, RAM 12, video decoder 15, and RAM 14. The audio decoder 11 receives the audio data from the stream demultiplexing unit 9 to execute a predetermined decode process. The RAM 10 temporarily stores data for the decode process of the audio decoder 11. The sub-picture decoder 13 receives sub-picture data from the stream demultiplexing unit 9 to execute a predetermined decode process. The RAM 12 temporarily stores data for the decode process of the sub-picture decoder 13. The video decoder 15 receives video data from the stream demultiplexing unit 9 to execute a predetermined decode process. The RAM 14 temporarily stores data for the decode process of the video decoder 15.

Furthermore, the information playback apparatus includes a video processor 17, video encoder 18, and digital-to-analog converter 16. The video processor 17 synthesizes the data from the video decoder 15 with the data from the sub-picture decoder 13 in accordance with the instruction from the system controller 22. The video encoder 18 converts the synthesized data from the video processor 17 into a video signal to be displayed, and displays the obtained video signal on the display device 20. The digital-to-analog converter 16 converts the data from the audio decoder 11 into an analog audio signal, and outputs the obtained analog audio signal to a loudspeaker 19 or the like.

The information playback apparatus also includes an operation unit 21 and the system controller 22. The operation unit 21 has various operation keys for outputting instructions to the system controller 22. For example, the operation keys include a playback key for instructing to start playback, a stop key for instructing to stop playback, a menu key for instructing to display the menu window, and a resume key for instructing to resume playback of content from the menu window display state, i.e., from the stop position of the content upon displaying the menu window. The system controller 22 controls the overall information playback apparatus. Note that the operation unit 21 may be arranged in a remote controller, or in the operation panel of the information playback apparatus main body.

The information playback apparatus also includes a flash ROM 23, CPU 24, and RAM 25. The flash ROM 23 stores a program and data for controlling each element of the apparatus and the overall apparatus. The CPU 24 controls the system controller 22 by executing calculation processing in accordance with the program and data stored in the flash ROM 23. The RAM 25 temporarily stores data.

The system controller 22 includes a menu window display processing unit 221, resume playback processing unit 222, and resume information storing unit 223 as elements which characterize this embodiment of the present invention.

Upon pressing the menu key during playback of content, i.e., while displaying the video data of the content on the display device 20, and/or while outputting the audio data of the content from the loudspeaker 19, the menu window display processing unit 221 stops playback of the content to execute a process for displaying the menu window in place of the content on the display device 20. The menu window display processing unit 221 also generates resume information containing content identification information which identifies the content, and stop position information indicating the position at which playback of the content is stopped upon pressing the menu key. The resume information storing unit 223 stores the generated resume information.

Upon depression of the resume key while displaying the menu window on the display device 20, the resume playback processing unit 222 acquires the resume information from the resume information storing unit 223. In accordance with the content identification information and stop position information contained in the resume information, the resume playback processing unit 222 resumes playback of the stopped content in place of the menu window to display the video data of the resume-played content on the display device 20 in place of the menu window, and/or output the audio data of the resume-played content from the loudspeaker 19.

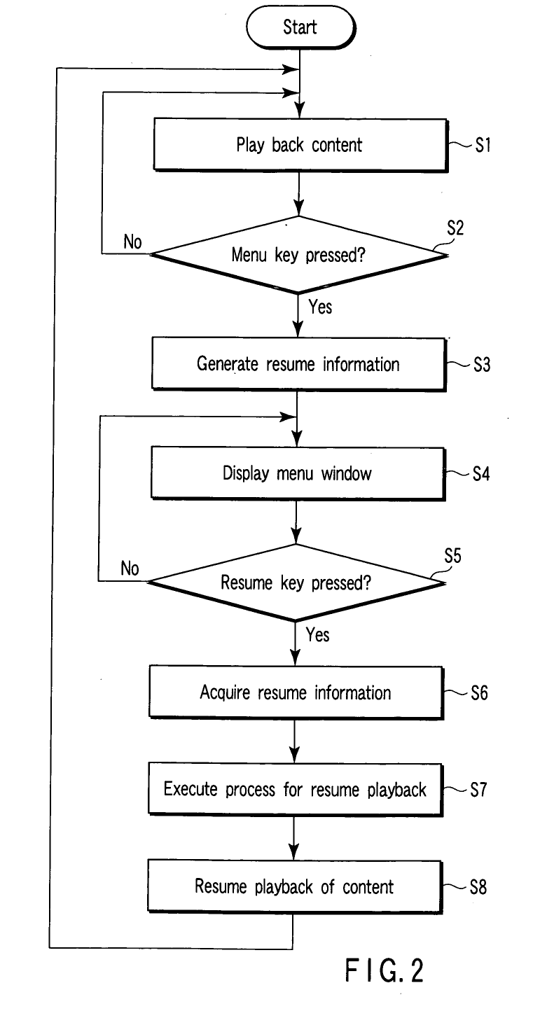

One example of a process associated with the resume key of the above-described information playback apparatus according to this embodiment will be described next with reference to the flowchart shown in FIG. 2. For example, content recorded on the optical disk 1 is played back in the following description with reference to FIG. 2. However, a person skilled in the art would understand that the same process applies when content stored in the hard disk is played back.

When the user inserts the optical disk 1 into the information playback apparatus and presses the playback key of the operation unit 21, playback of the content on the optical disk 1 starts. The display device 20 displays video data, and the loudspeaker 19 outputs audio (step S1).

When the user presses the menu key of the operation unit 21 during playback of the content (step S2: YES), the menu window display processing unit 221 generates resume information containing content identification information which identifies the content, and stop position information indicating the position at which playback of the content is stopped. The resume information storing unit 223 stores the generated resume information (step S3). On the other hand, when the user does not press the menu key during playback of the content (step S2: NO), the content is kept played back in step S1.

After step S3, the menu window display processing unit 221 stops playback of the content, and displays the menu window in place of the content on the display device 20 (step S4).

When the user presses the resume key of the operation unit 21 while displaying the menu window on the display device 20 (step S5: YES), the resume playback processing unit 222 acquires the resume information from the resume information storing unit 223 (step S6). On the other hand, when the user does not press the resume key while displaying the menu window (step S5: NO), the menu window is kept displayed in step S4.

After step S6, the resume playback processing unit 222 executes a process of resuming, from a position corresponding to the stop position information in the resume information, playback of the content corresponding to the content identification information in the resume information, i.e., the content which is stopped upon displaying the menu window (step S7). As a result of the steps, the video of the resume-played content is displayed on the display device 20, and the audio of the resume-played content is output from the loudspeaker 19 in place of the menu window (step S8). The process returns to step S1.

As described above, the information playback apparatus according to this embodiment has the resume key for executing a process of resuming, from the menu window display state, playback of the content which has been played back until the menu window is displayed. This resume key can be arranged in at least one of the main body and remote controller.

The resume key is a dedicated key for resuming, from the menu window display state, playback of the content which has been played back until the menu window is displayed. Hence, in order to resume, from the menu window display state, playback of the content which has been played back until the menu window is displayed, the user can easily recognize that the resume key should be pressed without being confused. With this process, the user can accurately resume playback of the content by easy operation, thus improving the user operability.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. An information playback apparatus which plays back information recorded on a recording medium, and displays the information on a display unit, comprising:
a menu window display processing unit configured to, when pressing a menu key during playback of the information, stop playback of the information and display a menu window in place of the information on the display unit; and
a resume playback processing unit configured to, when pressing a resume key while displaying the menu window on the display unit, resume playback of the information stopped to be played back, and display the resume-played information on the display device.

2. An apparatus according to claim 1, which further comprises a storage device, and in which, when pressing the menu key during playback of the information, the menu window display processing unit generates resume information containing identification information which identifies the information being playbacked and stop position information indicating a position at which playback of the information is stopped, and stores the generated resume information in the storage device, and
when pressing the resume key while displaying the menu window on the display device, the resume playback processing unit acquires the resume information from the storage device, and resumes playback of the information corresponding to the identification information in the resume information, from a position corresponding to the stop position information in the resume information.

3. An apparatus according to claim 2, wherein the resume key is arranged in a remote controller apparatus which remotely controls a main body of the information playback apparatus.

4. An apparatus according to claim 1, wherein the resume key is arranged in a remote controller apparatus which remotely controls a main body of the information playback apparatus.
